(19) United States
(12) Patent Application Publication
(10) Pub. No.: US 2002/0047384 A1
(43) Pub. Date: Apr. 25, 2002

(54) Blower

(75) Inventor: Kaoru Matsumoto, Miyota-machi (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 09/902,273

(22) Filed: Jul. 11, 2001

(30) Foreign Application Priority Data
Jul. 27, 2000 (JP) 2000-227353

(51) Int. Cl. H02K 5/00

(52) U.S. Cl. 310/89

(57) ABSTRACT

To attain the cost saving, the integration of an impeller and a motor yoke of an outer rotor type motor drive blower can be performed in a one-touch manner in a working process for fixedly attaching the motor yoke within the impeller. The motor yoke 6a is formed to have a cylindrical portion. Also, the impeller 5 is integrally formed of elastic synthetic resin with a cylindrical portion 5a within which the motor yoke 6a can be fixedly attached and fans 5b around the cylindrical portion with hooking members (bosses) 12 for the motor yoke 6a. Then, the motor yoke 6a and the impeller 5 are integrally formed with each other by engaging the elastic hooking members 12 with the motor yoke 6a when the motor yoke 6a is fixedly attached within the cylindrical portion 5a of the impeller 5.

### BACKGROUND OF THE INVENTION

1. Field of the Invention

The present invention relates to an improvement of a blower used in various office automation (hereinafter referred to as “OA”) equipment or the like.

2. Description of the Related Art

Since OA equipment such as a computer or a copying machine contain a number of electronic parts in their casing, a large amount of heat generated therefrom may destroy the electronic parts. Therefore, a blower is mounted in a ventilation hole provided in the casing to discharge the internal heat to the outside of the casing.

The conventional blower of this type will be described in FIG. 9.

As shown in FIG. 9, a shaft 4 is rotatably inserted and supported through bearings 2 and 3 in a sleeve-like portion la at the center of a casing 1.

This shaft 4 is mounted in a central portion (central portion of a cup portion 5a) of an impeller 5 constituting of the cup portion (bottomed cylindrical portion) 5a and a fan 5b around the cup portion 5a.

A motor yoke 6a is molded on the inner circumference of the cup portion 5a, and a ring-shaped permanent magnet 6b, being the main constitutional component of a rotor (outer rotor) 6 together with the motor yoke 6a, is fixed to the inner circumference of the motor yoke 6a.

A stator 7 provided with a stator iron core 7a and a winding 7b facing the permanent magnet 6b is fixed to the outside of the above sleeve-like portion 1a. A PC board 8 on which an electronic circuit is mounted is installed on the lower portion of the stator 7, whereby the stator 7 and the rotor 6 are operated as the stator and rotor of a brushless DC motor by supplying a predetermined amount of current to the stator winding 7b.

The stator winding 7b and the electronic circuit of the PC board 8, to which a lead wire 10 is connected are linked to each other through a pin 9.

In the blower thus constructed, when the power source of a predetermined DC voltage is applied to the lead wire 10, the current controlled by the electronic circuit on the PC board 8 flows to the stator winding 7b. Accordingly, a magnetic flux flow is generated from the stator iron core 7a, and the rotor 6 rotates around the shaft 4 by the mutual magnetic action with the magnetic flux flow from the permanent magnet 6b. Then, the impeller 5 formed integrally with the motor yoke 6a of the rotor 6 rotates to generate an air-blow.

As described above, in the outer rotor type motor driving blower, the rotatably supported shaft 4 is provided to the motor yoke 6a or the impeller 5 (in the example described above, to the impeller 5 formed integrally with the motor yoke 6a). And, the impeller 5 rotates around the stator 7 together with the motor yoke 6a to generate an air-blow.

And, the impeller 5 and the motor yoke 6a have been conventionally integrated as follows.

First, the case where the impeller 5 is provided with the shaft 4 will now be described with reference to FIGS. 10 and 11. FIG. 10 is a plan view showing a primary part. FIG. 11 is a cross-sectional view taken along the line XI-0-XI of FIG. 10. Besides, the same reference numerals indicate identical or corresponding portions in the accompanying drawings of this specification.

According to this example, the cylindrical motor yoke 6a with an end portion being flanged inwardly to some extent, which corresponds to the bottom surface side of the cup portion 5a of the impeller 5 is formed through an insert molding on the inner circumference of the cup portion 5a of the impeller 5. In this case, the left side end surface of the motor yoke 6a in FIG. 11 is covered by a synthetic resin cover 101 while molding the impeller to prevent the motor yoke 6a from being pulled out. Thus, the impeller 5 and the motor yoke 6a are formed integrally with each other.

In addition to the above, the above-described “cylindrical shape with an end portion flanged inwardly to some extent” will hereinafter be called “flanged cylindrical portion” in this specification.

An example where the motor yoke 6a is provided with the shaft 4 will now be described with reference to FIGS. 12 and 13. FIG. 12 is a plan view showing a primary part. FIG. 13 is a cross-sectional view taken along the line XIII-0-XIII in FIG. 12.

In this example, the cup-form motor yoke 6a (bottomed cylindrical shape) provided with the shaft 4 is fixedly attached to the interior surface of the cup portion 5a of the impeller 5. In this case, a plurality of synthetic resin bosses 121 molded inside of the bottom surface of the cup portion 5a while molding the impeller are inserted into through-holes 6al formed on the bottom surface of the motor yoke 6a. Thereafter, the head portions (tip end portions) of the synthetic resin bosses 121 are heated and pressurized for a heat-press to prevent the impeller 5 from being pulled out. Accordingly, the impeller 5 and the motor yoke 6a are integrally formed.

However, as far as the conventional integration technology in the impeller 5 and the motor yoke 6a is concerned, numbers of the molding process for the insert molding are increased in the former while in the latter, the heat-press process is required to prevent the impeller 5 from being pulled out. In either case, an effective cost performance has not been achieved.

### SUMMARY OF THE INVENTION

In the light of the foregoing defective points in the prior art, the object of the present invention is to provide a blower in which the integration of an impeller and a motor yoke can be realized at low cost.

In order to attain the above object, according to a first aspect of the present invention, there is provided an outer rotor type motor drive blower comprising a shaft rotatably supported by bearings in a motor yoke or an impeller, the impeller being integrally formed with the motor yoke, and the impeller rotating around a stator together with the motor yoke to generate an air-blow, wherein the motor yoke is formed to have at least a cylindrical portion, the impeller has a cylindrical portion within which at least the motor yoke can be fixedly attached and has a fan around the outer circumference of the cylindrical portion, the impeller has hooking members with the motor yoke integrally formed of elastic synthetic resin, and the motor yoke and the impeller are integrally formed with each other while the motor yoke is fixedly attached within the cylindrical portion of the impeller and the hooking members are engaged with the motor yoke.

According to a second aspect of the present invention, there is provided an outer rotor type motor drive blower comprising a shaft rotatably supported by bearings in a motor yoke or an impeller, the impeller being integrally formed with the motor yoke, and the impeller rotating around a stator together with the motor yoke to generate an air-blow, wherein the motor yoke is formed to have a substantially bottomed cylindrical shape provided with the shaft and through holes on a bottom surface, the impeller has a bottomed cylindrical portion within which the motor yoke can be fixedly attached and has fans around the outer circumference of the bottomed cylindrical portion, the impeller has bosses provided with hooking projection portions around the outer circumference at tip ends inside of a bottom surface of the bottomed cylindrical portion, which is formed of elastic synthetic resin, and the motor yoke and the impeller are integrally formed with each other while the motor yoke is fixedly attached within the bottomed cylindrical portion of the impeller, and the bosses are press-fitted in the through holes and the hooking projection portions of the bosses are engaged with end edges of the through holes when fixing and attaching is performed.

According to a third aspect of the present invention, there is provided an outer rotor type motor drive blower comprising a shaft rotatably supported by bearings in a motor yoke or an impeller, the impeller being integrally formed with the motor yoke, and the impeller rotating around a stator together with the motor yoke to generate an air-blow, wherein the motor yoke is formed to have a substantially bottomed cylindrical shape provided with the shaft, the impeller has a flanged cylindrical portion within which at least a cylindrical portion of the motor yoke and edge portions of an outer circumference of a bottom portion of the motor yoke can be fixedly attached and has fans around the outer circumference of the flanged cylindrical portion, the impeller has hooking claws to an opening edge of the motor yoke formed of elastic synthetic resin, and the motor yoke and the impeller are integrally formed with each other while the motor yoke is fixedly attached within the flanged cylindrical portion of the impeller, and the hooking claws are engaged with the opening edge of the motor yoke.

According to a fourth aspect of the present invention, there is provided an outer rotor type motor drive blower comprising a shaft rotatably supported by bearings in a motor yoke or an impeller, the impeller being integrally formed with the motor yoke, and the impeller rotating around a stator together with the motor yoke to generate an air-blow, wherein the motor yoke is formed to have at least a cylindrical portion, the impeller has the shaft, a bottomed cylindrical portion within which the motor yoke can be fixedly attached has fans around the outer circumference thereof, the impeller has hooking claws to an opening edge of the motor yoke integrally formed of elastic synthetic resin, and the motor yoke and the impeller are integrally formed with each other while the motor yoke is fixedly attached within the bottomed cylindrical portion of the impeller, and the hooking claws are engaged with the opening edge of the motor yoke.

According to the present invention, the impeller is integrally formed of elastic synthetic resin by means of hooking members with the motor yoke (the bosses formed with hooking projection portions at the outer circumference of the tip ends in case of the second aspect and the hooking claws to the opening edge of the motor yoke in case of the third and fourth aspects).

Namely, the hooking members formed in the impeller are elastic. Accordingly, the integration between the motor yoke and the impeller can be realized by engaging the hooking members with the motor yoke in a one-touch manner or a similar engagement work in the working steps of fixing the motor yoke within the cylindrical portion of the impeller.

### BRIEF DESCRIPTION OF THE DRAWINGS

FIG. 1 is a plan view showing the primary part of a blower according to a first embodiment of the present invention.

FIG. 2 is a cross-sectional view taken along the line II-0-II of FIG. 1.

FIG. 3 is a plan view showing a motor yoke shown in FIG. 1 as an independent component.

FIG. 4 is an enlarged cross-sectional view taken along the line IV-IV of FIG. 1.

FIG. 5 is a plan view showing the primary part of a blower according to a second embodiment of the present invention.

FIG. 6 is a cross-sectional view taken along the line VI-0-VI of FIG. 5.

FIG. 7 is a plan view showing the primary part of a blower according to the third embodiment of the present invention.

FIG. 8 is a cross-sectional view taken along the line VIII-0-VIII of FIG. 7.

FIG. 9 is a partially omitted cross-sectional view of a conventional blower.

FIG. 10 is a plan view showing the primary part of the conventional blower.

FIG. 11 is a cross-sectional view taken along the line XI-0-XI of FIG. 10.

FIG. 12 is a plan view showing the primary portion of another blower.

FIG. 13 is a perspective view taken along the line XIII-0-XIII of FIG. 12.

### DESCRIPTION OF THE PREFERRED EMBODIMENTS

An embodiment of the present invention will now be described with reference to the accompanying drawings.

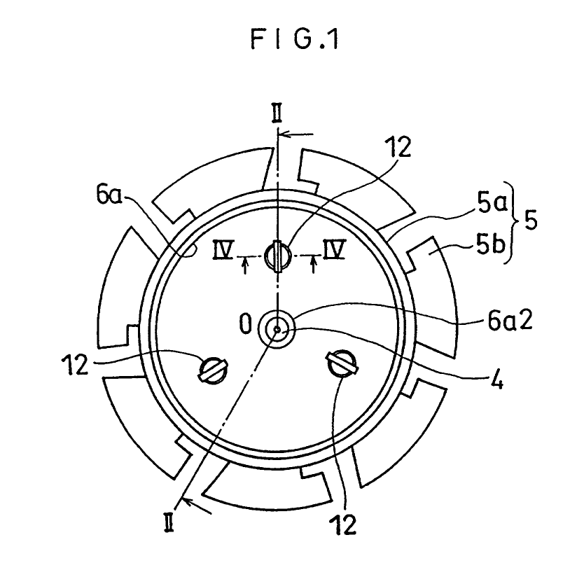

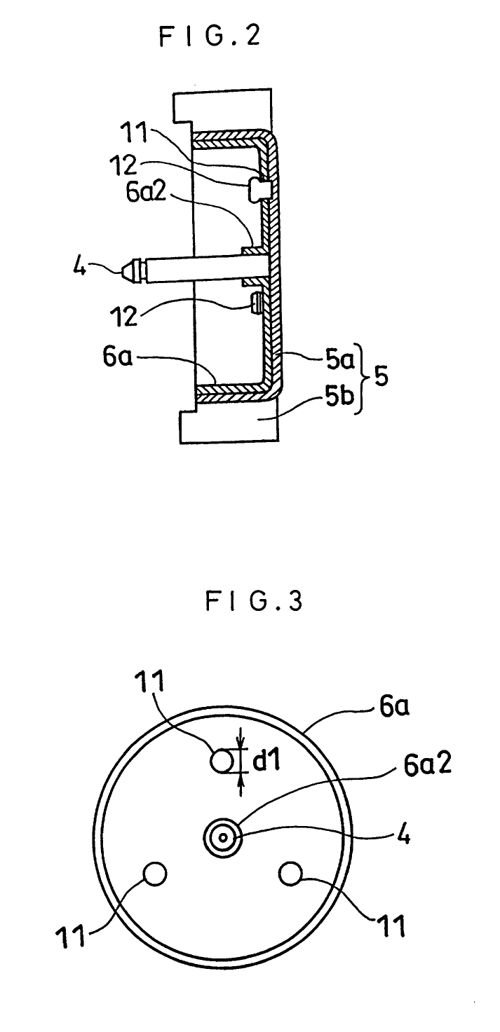

FIG. 1 is a plan view showing the primary part of a blower according to a first embodiment of the present invention. And, FIG. 2 is a cross-sectional view taken along the line II-0-II of FIG. 1.

A motor yoke 6a substantially formed into a cup shape (bottomed cylindrical shape) in the first embodiment is provided with a shaft 4, and circular through-holes 11 are formed in a bottom surface thereof. The shaft 4 is press-fitted and fixed by means of caulking or the like within a boss portion 6a2 formed in a central portion inside of the bottom surface of the motor yoke 6a.

FIG. 3 is a plan view of the motor yoke 6a as an independent part with the shaft 4. As shown in FIG. 3, the through-holes 11, three in total, are each formed at positions at every 120 degrees on a circumference at the shaft 4 as the center. A d1 in FIG. 3 represents a diameter of the through-holes 11.

The impeller 5 as shown in FIGS. 1 and 2 has the cup portion 5a (bottomed cylindrical portion) shaped to fixedly attach the motor yoke 6a within the inside thereof and has fans 5b on the outer circumference of the cup portion Sa. Moreover, the impeller 5 has bosses 12 (hook members) inside of the bottom surface of the cup portion 5a and is integrally formed of flexible synthetic resin.

As shown in FIG. 1, the three numbers (in this case) of bosses 12 whose number is the same as that of the through-holes 11 are provided in positions corresponding to the through-holes 11 to the shaft 4.

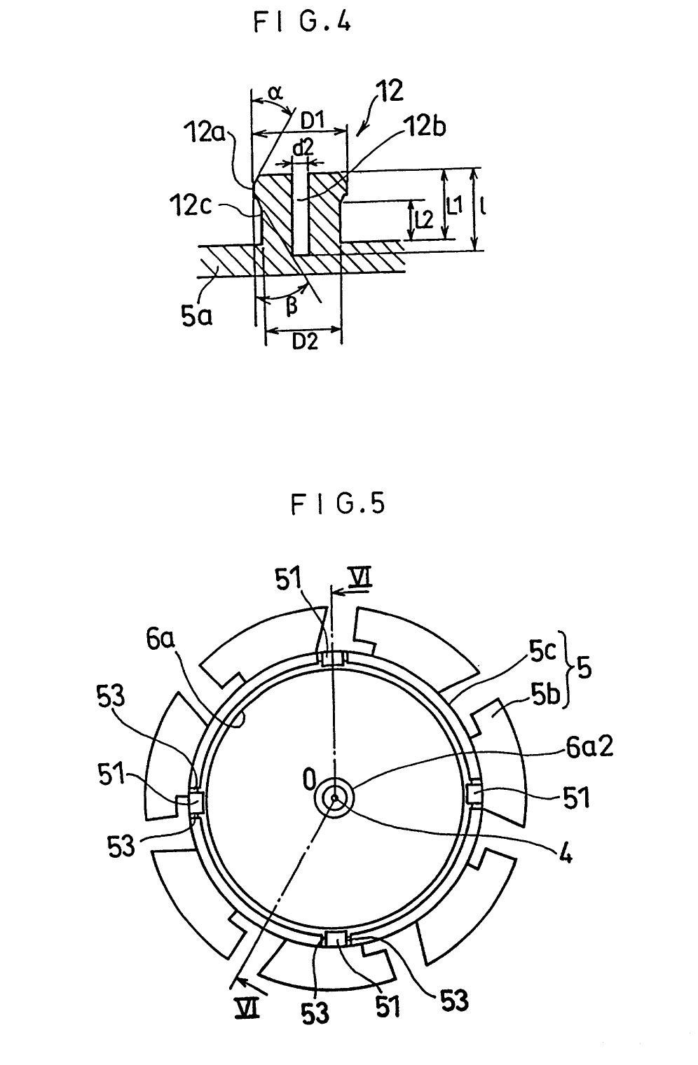

FIG. 4 detailing the boss 12 is an enlarged cross-sectional view taken along the line IV-IV of FIG. 1. A hooking projection 12a is formed on an outer circumference of a tip end (an upper end in the figure) of the boss 12 as shown in FIG. 4. In this example, a slit 12b is also formed directed from the central portion of the boss 12 tip-end surface to the bottom surface of the cup portion 5a.

In FIG. 4, D1 is the maximum diameter of the hooking projection 12a of the boss 12, D2 is the diameter of the fitting portion 12c to the through-hole 11 of the boss 12, L1 is the length (height) of the boss 12, and L2 is the length of the fitting portion 12c. Also, 1 (denoting a lower case of L) is the depth of the slit 12b, d2 is the groove width of the slit 12b, α is the sliding angle for press-fitting the boss 12 into the through hole 11, and β is the pull-off angle upon molding the boss 12.

In this case, D1 is set to be greater than the diameter d1 of the through hole 11 and to be a value not exceeding a dimension where the slit groove width d2 and the diameter d1 of the through hole 11 are added (the value that is at maximum the diameter dl of the through hole 11 which will be equal to the outer diameter D 1 obtained when the fitting portion 12c is crashed). This will make the boss 12 possible to press-fit into the through hole 11.

Note in this case that D2 is set to substantially the same dimension as the diameter d1 of the through hole 11, so that the fitting portion 12c is fitted into the through hole 11 without any displacement.

L2 can be set to a dimension within the range of 80 to 100% of a thickness of the motor yoke 6a. In this case, approximately 80% of the thickness is chosen. And, the smaller the value of L2 is, the larger the boss 12 gains a hooking force to the impeller 5.

The slit groove width d2 is set to the dimension meeting the following relation, d2>D1-D2. The slit depth 1 can be set to be the same as the length L1 of the boss 12 or to be slightly greater than the length. However, the length of the slit depth 1 can be set less than the one of the of the boss 12. The larger the slit groove width d2 or the slit depth 1, the easier the boss 12 can be press-fitted into the through hole 11.

With respect to the general concept in the sliding angle α and β, the angle α is set to be an angle at which the press-fitting of the boss 12 into the through hole 11 can easily be performed. And, the angle β is set under consideration of the following; the die-detaching can be easily performed following the molding of the boss 12, and the pulling-out of the boss 12 from the through hole 11 is not easily handled after press-fitting the boss 12 into the through hole 11. Since the optimum values change depending upon the slit width d2 or the synthetic resin material used or the like, the angles α and β, in this case are both set at 30 degrees.

With such an arrangement, the motor yoke 6a is fixedly attached within the cup portion 5a of the impeller 5 while each boss 12 is inserted into the associated through hole 11 formed in the bottom of the motor yoke 6a. Thus, the hooking portion 12a of each boss 12 is engaged with the end edge (motor yoke 6a) of the through hole 11, so that the impeller is prevented from being pulled apart from the motor yoke 6a and is integrated therewith.

Each boss 12 formed in the impeller 5 is formed integrally with the impeller 5 upon molding with elastic synthetic resin, so that each of boss 12 obtains an elastic character. Accordingly, when considering a working step of fitting to fix the motor yoke 6a within the cup portion 5a of the impeller 5, the integration of the motor yoke 6a and the impeller 5 is made by engaging the bosses 12 with the motor yoke 6a (through holes 11) in a one-touch manner or in a similar pressing work.

In the first embodiment, since the slit 12b is formed in each boss 12, when the boss 12 is press-fitted into the through hole 11 of the motor yoke 6a, an outer diameter of the boss 12 is deformed to make a smaller diameter in the slit groove width direction (i.e., the slit 12b is crashed). It is therefore easier to press-fit the boss 12 into the through hole 11.

In some cases, depending on the kind of the synthetic resin material, it will be difficult to form the hooking projection portion 12a over the full circumference of the tip end of the boss 12. In those cases, the following solution is taken; the hooking projection portion 12a is partially formed on the outer circumference of the tip end of the boss 12, and a removal hole (not shown in FIG. ) for the molds is partially formed on the outside of the cup portion 5a.

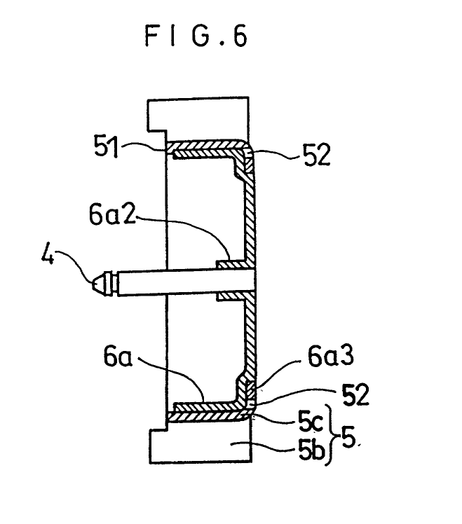

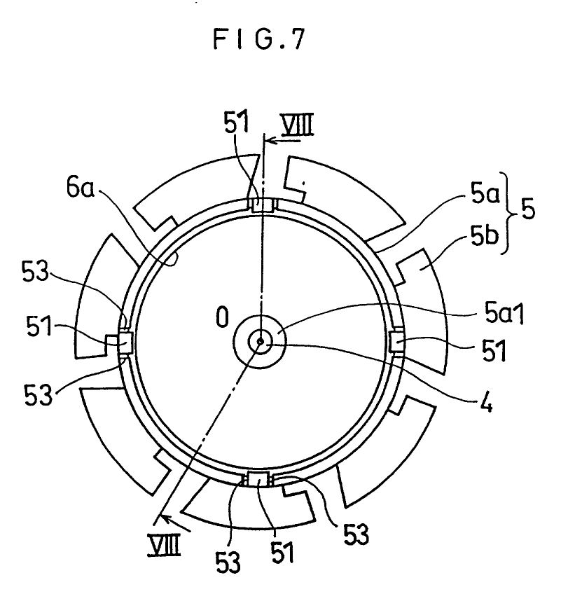

FIG. 5 is a plan view showing a primary part of a blower in accordance with a second embodiment of the present invention. FIG. 6 is a cross-sectional view taken along the line VI-0-VI of FIG. 5.

In the second embodiment, the motor yoke 6a is provided with a shaft 4 and formed substantially into a cup shape (bottomed cylindrical shape). Note that the motor yoke 6a has an annular recess portion 6a3 formed by slightly recessing to the opening surface side of the cup shaped portion on the outer circumferential side of the bottom surface of the cup shaped portion of the motor yoke 6a (the upper and lower sides in the right side surface in FIG. 6).

The shaft 4 is press-fitted and fixed by caulking or the like into a boss portion 6a2 formed at the central portion on the inside of the motor yoke 6a bottom surface.

The impeller 5 has a flanged cylindrical portion 5c within which the motor yoke 6a can be fixedly attached, and fans 5b is positioned around the outer periphery of the flanged cylindrical portion 5c. Moreover, the impeller 5 has hooking claws (hooking members) 51 extending at the opening edge of the motor yoke 6a in the opening edge portion of the flanged cylindrical portion 5c and is integrally formed of elastic synthetic resin.

Hooking claws 51 as shown in FIG. 5, four in total, are each provided at every 90 degrees around the shaft 4 engaging to support the opening end face of the motor yoke 6a at the four positions.

With such an arrangement, the motor yoke 6a is fixedly attached 9. within the flanged cylindrical portion 5c of the impeller 5 And, each hooking claws 51 are engaged with the opening edge of the motor yoke 6a, so that the impeller 5 is prevented from being pulled apart from the motor yoke 6a resulting in an integrated configuration.

In this case, the impeller 5 clamps the cylindrical portion of the cup shaped portion of the motor yoke 6a from both sides (right and left sides in FIG. 6) by the engagement of the above-described hooking claws 5 1 with the hooking claws 51 and the flanged portion of the flanged cylindrical portion 5c, so that the impeller 5 is prevented from being pulled apart resulting in an integrated configuration with the motor yoke 6a.

Each hooking claw 51 formed in the impeller 5 is formed integrally with the impeller 5 upon molding with elastic synthetic resin and retains an elastic character. Accordingly, when considering a working prodedure of fitting to fix the motor yoke 6a within the flanged cylindrical portion 5c of the impeller 5, the integration of the motor yoke 6a and the impeller 5 is made by the engagement of the hooking claws 51 with the motor yoke 6a (opening edge) in a one-touch manner or in a similar pressing work.

Incidentally, when the motor yoke 6a is fitted to fix within the flanged cylindrical portion 5c of the impeller 5, the flanged portion of the flanged cylindrical portion 5c (portion corresponding to the bottom surface of the motor yoke 6a) is fitted in the annular recess portion 6a3 of the motor yoke 6a, so that the bottom surfaces of the motor yoke 6a and the impeller 5 assembled together become flushed.

Reference numeral 52 in FIG. 6 denotes the holes for detaching the die to mold the hooking claws 51 upon molding the impeller 5. Reference numeral 53 in FIG. 5 denotes undercuts for the hooking claws 51 needed when hooking to the opening edge of the motor yoke 6a.

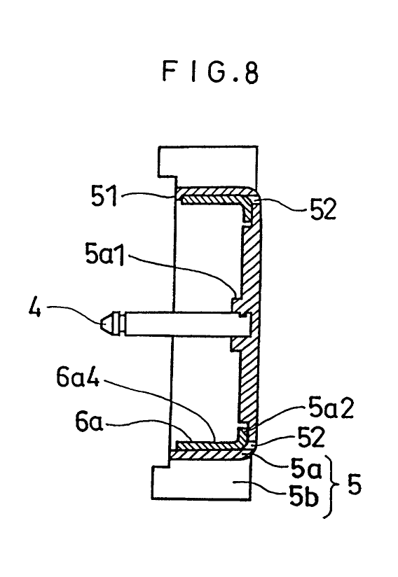

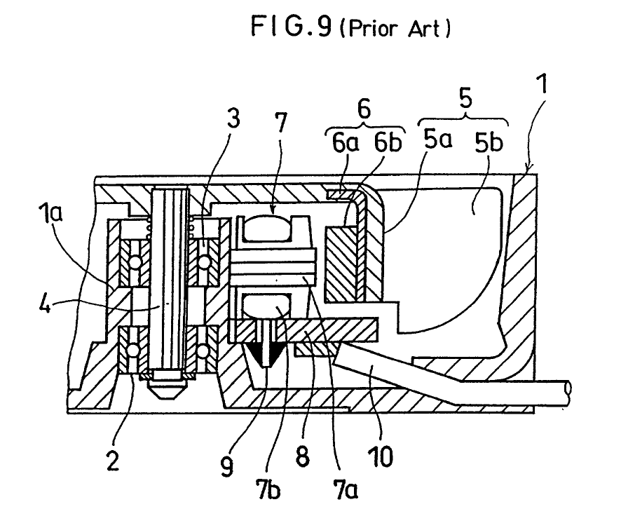

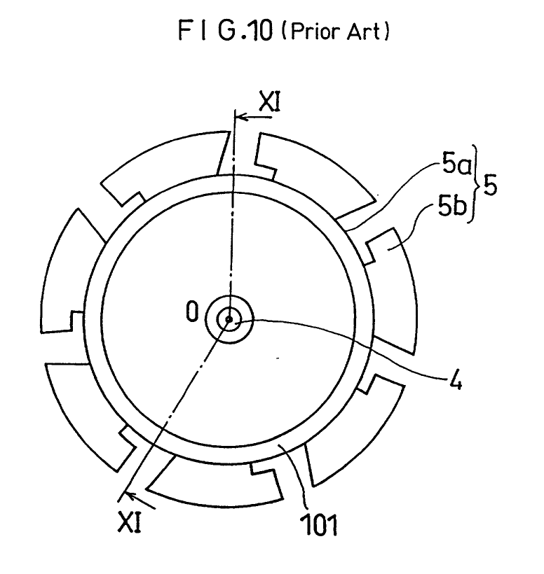

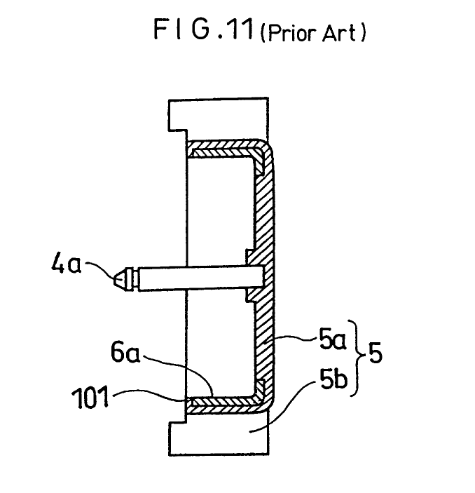

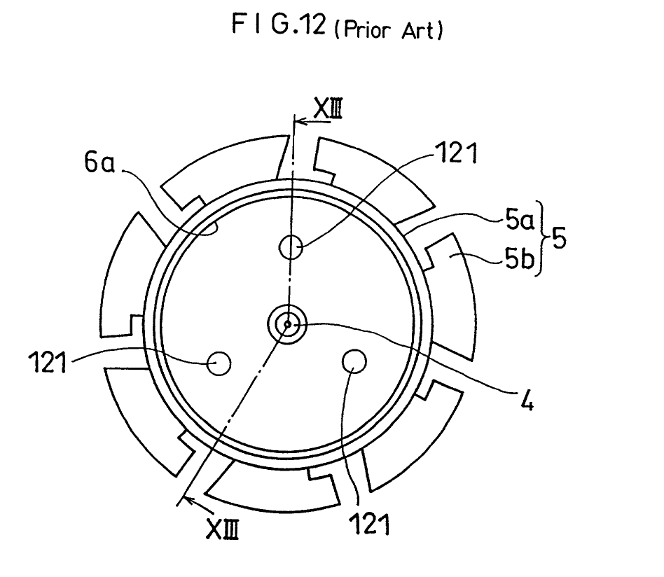

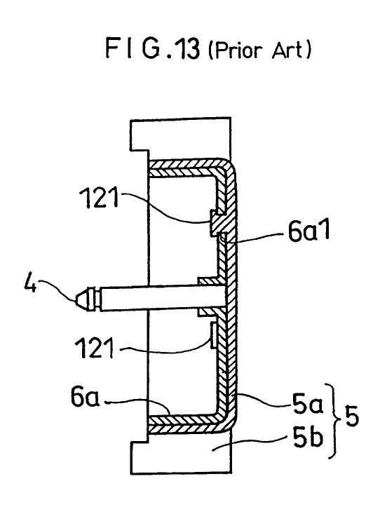

FIG. 7 is a plan view showing a primary part of a blower in accordance with a third embodiment of the present invention. FIG. 8 is a cross-sectional view taken along the line VIII-0-VIII of FIG. 7.

In the third embodiment, the motor yoke 6a is formed to have at least cylindrical portion, a flanged cylindrical portion 6a4 in this case.

The impeller 5 is provided with the shaft 4 and has a cup portion (bottomed cylindrical portion) 5a having an inner shape within which the motor yoke 6a is fitted to fix and fans 5b around the cup portion 5a. The impeller 5 has hooking claws 51 extending to the opening edge of the motor yoke 6a at the opening edge portion of the cup portion 5a and is integrally formed of elastic synthetic resin. In this case, an annular recess portion 5a2 slightly recessed on the bottom surface side of the cup portion 5a is formed on the outer circumferential side of the inner bottom portion of the cup portion 5a of the impeller 5.

The shaft 4 is press-fitted and fixed by caulking or the like to a boss portion 5a1 formed at the central portion on the inside of the bottom surface of the impeller 5.

Hooking claws 51, four in total, as shown in FIG. 7 are provided at every 90 degrees around the shaft 4 and engages to support the opening end face of the motor yoke 6a at the four positions.

With such an arrangement, the motor yoke 6a is fixedly attached within the bottomed cylindrical portion 5a of the impeller 5 while each hooking claws 51 are engaged with the opening edge of the motor yoke 6a, so that the impeller 5 is prevented from being pulled apart from the motor yoke 6a resulting in an integrated configuration with the motor yoke 6a.

In this case, the impeller 5 clamps the flanged cylindrical portion 6a4 of the cup shaped portion of the motor yoke 6a from both sides (right and left sides in FIG. 8) by the engagement of the above-described hooking claws 51 with the hooking claws 51 and the outer circumferential portion of the bottom portion of the cup portion 5a, so that the motor yoke 6a is prevented from being pulled apart resulting in an. integrated configuration with the motor yoke 6a.

Each hooking claw 51 formed in the impeller 5 is formed integrally with the impeller 5 upon molding with elastic synthetic resin and retains an elastic character. Accordingly, when considering a working step of fixedly attaching the motor yoke 6a within the cup portion 5a of the impeller 5, the integration of the motor yoke 6a and the impeller 5 is made by the engagement of the hooking claws 51 with the motor yoke 6a (opening edge) in a one-touch manner or in a similar pressing work.

Incidentally, when the motor yoke 6a is fixedly attached within the cup portion 5a of the impeller 5, the flanged portion of the flanged cylindrical portion 6a4 (portion corresponding to the bottom surface of the impeller 5) is fitted in the annular recess portion 5a2 formed on the outer circumferential side of the inner surface of the bottom portion of the cup portion 5a of the impeller 5, so that the bottom surfaces of the motor yoke 6a and the impeller 5 assembled together become flushed.

Reference numeral 52 in FIG. 8 denotes the holes for detaching the die to mold the hooking claws 51 upon molding the impeller 5. Reference numeral 53 in FIG. 7 denotes undercuts needed when the hooking claws 51 are hooked to the opening edge of the motor yoke 6a.

As described above, the impeller according to the present invention is integrally formed of elastic synthetic resin with hooking members (bosses and hooking claws formed with the hooking projection portions) of the motor yoke. Accordingly, when considering a working process of fixedly attaching the motor yoke within the cylindrical portion of the impeller, the integration of the motor yoke and the impeller is made by engaging the elastic hooking members formed in the impeller with the motor yoke in a one-touch manner or in a similar pressing work attaining a further low-cost integration.

What is claimed is:

1. An outer rotor type motor drive blower comprising a shaft rotatably supported by bearings in a motor yoke or an impeller, the impeller being integrally formed with the motor yoke, and the impeller rotating around a stator together with the motor yoke to generate an air-blow wherein:
said motor yoke is formed to have at least a cylindrical portion;
said impeller has a cylindrical portion within which at least said motor yoke can be fixedly attached and has fans around the outer circumference of the cylindrical portion, said impeller has hooking members with said motor yoke integrally formed of elastic synthetic resin; and
said motor yoke and said impeller are integrally formed with each other while said motor yoke is fixedly attached within the cylindrical portion of said impeller and said hooking members are engaged with said motor yoke.

2. An outer rotor type motor drive blower comprising a shaft rotatably supported by bearings in a motor yoke or an impeller, the impeller being integrally formed with the motor yoke, and the impeller rotating around a stator together with the motor yoke to generate an air-blow wherein:
said motor yoke is formed to have a substantially bottomed cylindrical shape provided with said shaft and through holes on a bottom surface;
said impeller has a bottomed cylindrical portion within which said motor yoke can be fixedly attached and has fans around the outer circumference of the bottomed cylindrical portion, said impeller has bosses provided with hooking projection portions around the outer circumference at tip ends inside of a bottom surface of the bottomed cylindrical portion and integrally formed of elastic synthetic resin; and
said motor yoke and said impeller are integrally formed with each other while said motor yoke is fixedly attached within the bottomed cylindrical portion of said impeller, and said bosses are press-fitted in said through holes and the hooking projection portions of said bosses are engaged with end edges of said through holes when the fitting and fixing are performed.

3. An outer rotor type motor drive blower comprising a shaft rotatably supported by bearings in a motor yoke or an impeller, the impeller being integrally formed with the motor yoke, and the impeller rotating around a stator together with the motor yoke to generate an air-blow wherein:
said motor yoke is formed to have a substantially bottomed cylindrical shape provided with said shaft,
said impeller has a flanged cylindrical portion within which at least a cylindrical portion of said motor yoke and edge portions of an outer circumference of a bottom portion of said motor yoke can be fixedly attached and has fans around the outer circumference of the flanged cylindrical portion, said impeller having hooking claws to an opening edge of said motor yoke and formed of elastic synthetic resin; and
said motor yoke and said impeller are integrally formed with each other while said motor yoke is fixedly attached within the flanged cylindrical portion of said impeller, and said hooking claws are engaged with the opening edge of said motor yoke.

4. An outer rotor type motor drive blower comprising a shaft rotatably supported by bearings in a motor yoke or an impeller, the impeller being integrally formed with the motor yoke to generate an air-blow, and the impeller rotating around a stator together with the motor yoke, wherein:
said motor yoke is formed to have at least a cylindrical portion;
said impeller has said shaft, a bottomed cylindrical portion within which said motor yoke can be fixedly attached and has fans around the outer circumference of the bottomed cylindrical portion; said impeller having hooking claws to an opening edge of said motor yoke and formed of elastic synthetic resin; and
said motor yoke and said impeller are integrally formed with each other while said motor yoke is fixedly attached within the bottomed cylindrical portion of said impeller, and said hooking claws are engaged with the opening edge of said motor yoke.
